(19) United States
(12) Patent Application Publication
(10) Pub. No.: US 2008/0009271 A1
(43) Pub. Date: Jan. 10, 2008

(54) System and method for disseminating sport statistics using a mobile telecommunications network

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/481,743

(22) Filed: Jul. 6, 2006

(51) Int. Cl. H04Q 7/22

(52) U.S. Cl. 455/414.1

(57) ABSTRACT

A system and method of providing sports statistics to one or more mobile telecommunications handsets during a sporting event is provided. Sports statistics relevant to a participant-highlighting event occurring during the sporting event, such as a baseball player coming up to bat at a baseball game, are delivered to a Subscriber's mobile telecommunications handset. The relevant statistics are generated and delivered to the handset during the participant-highlighting event. Subscribers can provide subscriber-specific criteria to customize the statistics information they receive.

### BACKGROUND OF THE INVENTION

This invention relates to a system and method for providing sports statistics, and more particularly to a system and method for disseminating sports statistics to one or more mobile telecommunications handsets during the sporting events.

While the invention is particularly directed to the art of mobile telecommunications systems, and will be thus described with specific reference thereto, it will be appreciated that the invention may have usefulness in other fields and applications.

Due to the ever increasing popularity of mobile telecommunications handsets, also known as cellular phones, a growing number of people have begun to carry one continuously throughout the day. These devices have been improved over time to provide data to users as well as conventional voice calls. Many handsets are even capable of connecting to the Internet via their wireless Networks.

Sports fans have a need for obtaining ready access to sports information particularly when it relates to their favorite sports player, team or sporting event. Many sports fans use sports statistics to enhance their knowledge and enjoyment of their favorite sporting events.

It is desirable to meet this need by providing the sports fans with sports statistics using their mobile handsets. The present invention contemplates a new and improved system and method that resolves the above-referenced needs and others.

### SUMMARY OF THE INVENTION

A system and method of providing sports statistics to one or more mobile telecommunications handsets during a sporting event is provided.

In accordance with one aspect of the invention, the method includes determining that the sporting event has created a participant-highlighting, obtaining a relevant group of the highlighted participant's sports statistics, and delivering at least portions of the relevant group of the highlighted participant's sports statistics to one or more mobile telecommunications handsets during or proximate the participant-highlighting event.

In accordance with another aspect of the invention, the system includes means for determining that the sporting event has created a participant-highlighting, means for obtaining a relevant group of the highlighted participant's sports statistics, and means for delivering at least portions of the relevant group of the highlighted participant's sports statistics to one or more mobile telecommunications handsets during or proximate the participant-highlighting event.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for providing sports statistics in accordance with the invention;

FIG. 2 is a flow chart illustrating a method of operation of the invention;

FIG. 3 is a flow chart further illustrating the method of operation of the invention; and

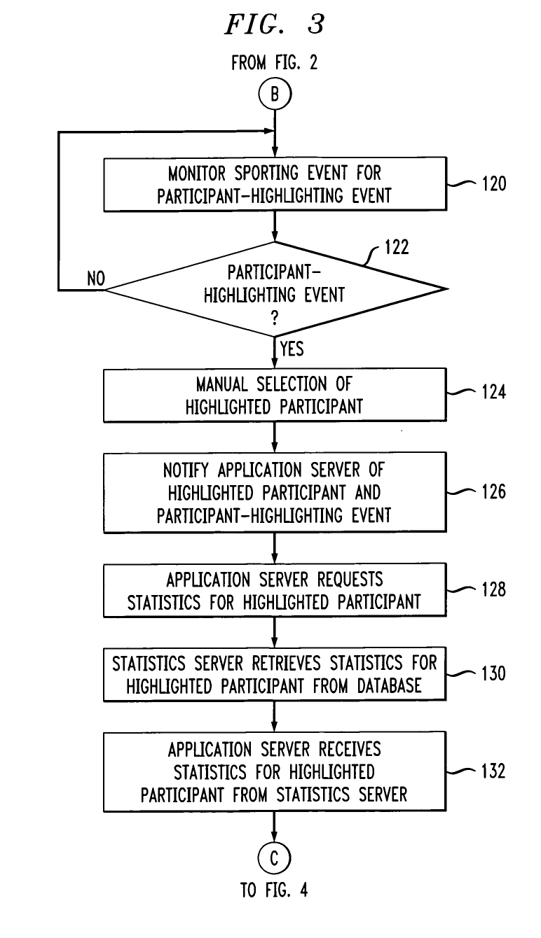

FIG. 4 is a flow chart further illustrating the method of operation of the invention.

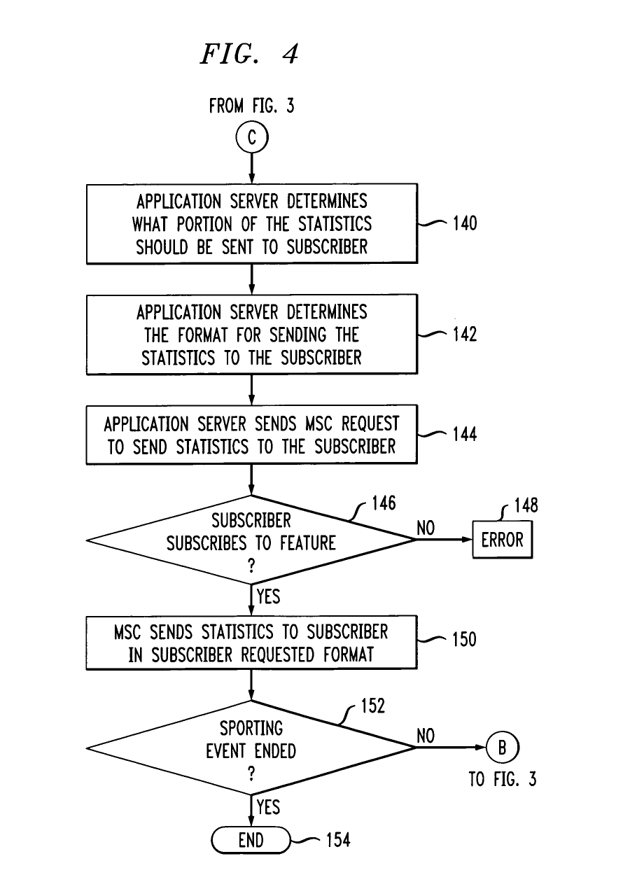

### DETAILED DESCRIPTION

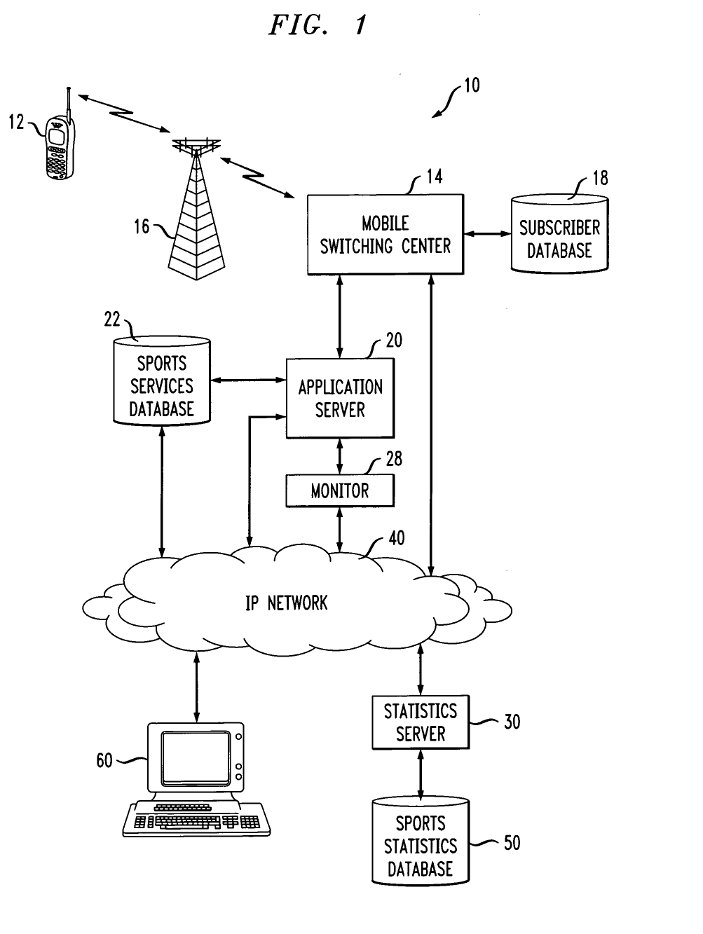

Referring now to the drawings wherein the showings are for purposes of illustrating the exemplary embodiments only and not for purposes of limiting the claimed subject matter, FIG. 1 provides a view of a system, shown generally at 10, for providing sports statistics to mobile telecommunications handsets, one of which is shown at 12.

The system 10 includes a portion of a mobile telecommunications network capable of providing the statistics to the handset 12 in the manner described below. The system 10 includes a Mobile Switching Center 14 and a Base Station 16 communicating with the mobile handset in a manner suitable for providing the sports statistics as described. Though only a single mobile handset 12, MSC 14 and Base Station 16 are shown for the purposes of simplicity, it should be appreciated that the system and method described herein can provide sports statistics to a plurality of mobile handsets for a plurality of different sporting events. The mobile telecommunications network (handset 12, Base Station 16 and MSC 14) can be a CDMA, GSM, or other known wireless, mobile telecommunications network.

The MSC communicates with one or more Subscriber databases, one of which is shown at 18, for obtaining Subscriber information as described below. The Subscriber Database 18 can be disposed in a Home Location Register (HLR) or other node in, or communicating with, the mobile telecommunications network.

The system 10 also includes an Application Server 20 suitable for performing the programmed logic capable of performing the tasks for providing the sports statistics as described herein. The Application Server 20 can be a standalone server communicating with the system 10 as shown, or it may be incorporated into one or more network nodes in the telecommunications system. A Sports Services Database 22 can be used for storing the subscriber-specific criteria described below for providing the specific sports statistics for the desired participant-highlighting events for the corresponding sporting events chosen by the subscriber. The subscriber-specific criteria can be associated with the corresponding subscriber in the database for ready access by the Application Server 20 for each individual subscriber.

A Statistics Server 30 is connected to the Application Server 20 for providing sports statistics for sporting event participants as described below. The Statistics Server 30 can be connected to the Application Server 20 by a network connection 40, such as the Internet, using suitable communications protocols for enabling rapid dissemination of information therebetween. A plurality of Application Servers 20 and Statistics Servers 30 may be used if so desired.

One or more Sports Statistics databases, one of which is shown at 50, are connected to the Statistics Server 30 for storing sports statistics for participants of the sporting event. It is contemplated that all of the sports statistics that may possibly be used can be stored here and associated with their corresponding participants in a known manner, such as for example, using a table lookup database.

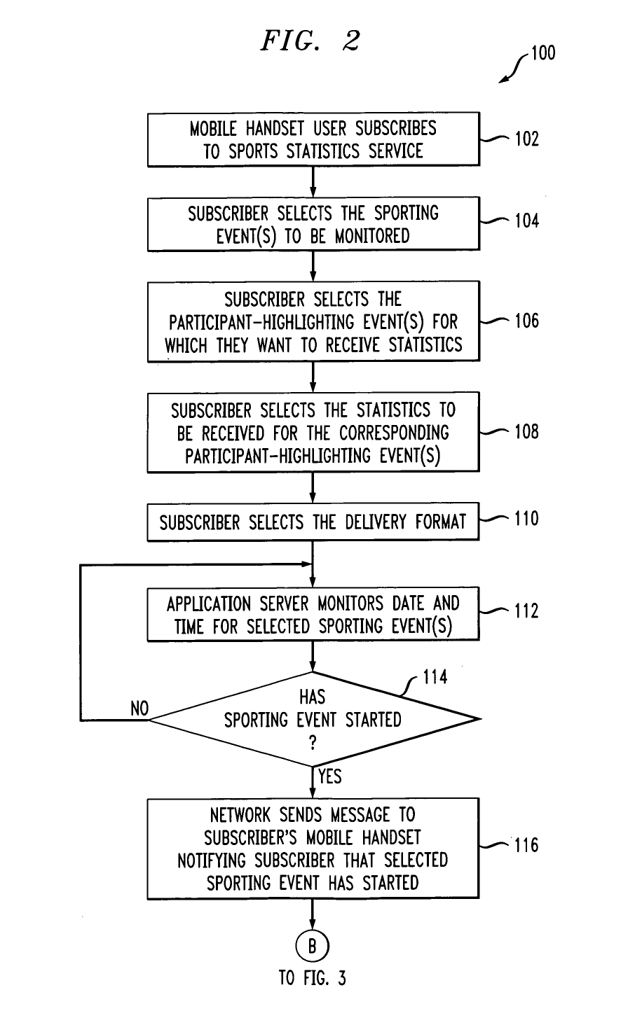

Referring now to FIG. 2, a method of providing sports statistics to a mobile telecommunications handset is shown generally at 100. Mobile handset users can subscribe to the statistics service at 102 for providing the statistics in the manner described herein. The service can be made available by their mobile telecommunications Network Provider, also known as a Service Provider. Service Providers could offer this feature as an optional feature in their networks and could charge a monthly fee for its use. The users, referred to as subscribers, can subscribe at 102 using their mobile handset, via a computer network connection, such as the Internet, or in other suitable manners. Though the term “subscriber” shall be used to refer to those users receiving the statistics service described herein, it should be appreciated that any users of mobile telecommunications handsets may receive this service, such as for example on a per-use basis.

Each individual Subscriber can select subscriber-specific criteria to personalize the sports service to their own tastes. The Subscriber can choose these criteria via a User Interface using a computer 60 connected to the Application Server 20 via a network connection, such as an IP network connection 40, or using a mobile handset 12 or in other suitable manners.

One example of the Subscriber-specific criteria includes the Subscriber selecting the sporting event, or events, for which he would like to receive the statistics at 104. For example, Subscriber A is a baseball fan and can select to receive the sports statistics for baseball games involving his favorite baseball team or teams, Subscriber B is a football fan and can select to receive statistics for his favorite football team, and Subscriber C is a soccer fan and he can select the games for which he wants to receive the statistics. Each Subscriber can choose specific events held on particular days and times, or she can choose every corresponding sporting event in a season, or some combination thereof, such as only the home games for a particular team, or only the games the Subscriber will be attending, etc.

Another example of the Subscriber-specific criteria capable of being provided by each Subscriber includes the Subscriber selecting, at 106, the particular participant-highlighting event, or events, typically occurring during the sporting event(s) for which they want to receive statistics. Participant-highlighting events are events occurring during the sporting event which emphasizes one or more of the participants, separate and apart from the other participants. These participants are referred to herein as highlighted participants, or highlighted players. The one or more highlighted participants are highlighted, or emphasized, as a result of, and thus during, the participant-highlighting event.

Examples of participant-highlighting events which can be selected for a baseball game can include, but are not limited to: a baseball player coming up to bat, a player entering or leaving the ball game, such as for example a pitcher, a player making an offensive play such as getting a hit, a walk, a run, etc., a player making a defensive play such as making a catch, making an out, striking out the batter, etc.

Examples of participant-highlighting events which can occur during football games can include, but are not limited to, a football player entering the game or leaving the game, a player getting hurt, a player running the ball or making a catch, a player making a tackle or a block, a player scoring, such as making a touchdown, a field goal or extra point, etc.

Examples of participant-highlighting events which can occur during a soccer game can include, but are not limited to, a player entering the game-or leaving the game, a player scoring a goal, a goalie making a save, a coach receiving a yellow-card, etc.

Another example of the Subscriber-specific criteria capable of being provided by each Subscriber includes the Subscriber selecting, at 108, the particular statistics she wishes to receive for the participant-highlighting event(s) selected in step 106. These statistics will be relevant to the highlighted player, or players, and to the participant-highlighting event. One example, which should not be considered limiting, includes the Subscriber choosing to have particular statistics for each baseball player coming up to bat delivered to the handset when the player is coming up to bat. The Subscriber chooses, for example, the batter's current batting average, lifetime batting average against the pitcher in place, length of time in the league, length of time with the current club, personal stats such as height, weight, age, etc. It is contemplated that the Subscriber can personalize the statistics delivered to them for each of the one or more different participant-highlighting events chosen above.

Another example of the Subscriber-specific criteria capable of being provided by each Subscriber includes the Subscriber indicating, at 110, the particular format in which the statistics are to be delivered to the subscriber's mobile handset. Examples of these delivery formats can include, but are not limited to, text messaging, SMS messages, voice messages, or other known formats for delivering information to a user of a mobile handset.

The Application Server 20 then monitors the date and time for the selected sporting event(s) at 112. The Application Server 20 can include a pre-defined, or dynamic, schedule of sporting events for this purpose.

When the selected sporting event starts as determined at 114, the Application Server 20 can send a message to the Subscriber's mobile handset informing of the start of the competition at 116. This notification can be provided in the subscriber-chosen delivery format, described in step 110, or in a format determined by the Service Provider.

The sporting event is then monitored for participant-highlighting events at 120. It is contemplated that this can be accomplished manually by a person monitoring/observing the sporting event shown as the Monitor 28 in FIG. 1. The Monitor 28 can monitor the game either in-person, such as in an announcer's booth, etc., or at a remote location using one or more “feeds” providing event information suitable for determining that a participant-highlighting event is occurring and the one or more highlighted participants associated with the event. This monitoring is done during the sporting event, however it may be delayed slightly, such as by a few seconds or less, if feeds are used for monitoring. It is contemplated that the statistics described below are to be provided contemporaneously, that is during or proximate in time, to the participant-highlighting event. Slight delays in determining the occurrence of a participant-highlighting event, and/or in obtaining the relevant statistics, and/or delivering them to the subscriber's handset, may occur.

Upon the occurrence of a participant-highlighting event at 122, the person monitoring selects the one or more highlighted participants at 124 for processing. The Monitor 28 can use a graphics user interface such as that provided by a suitable computer program to select the relevant highlighted participant(s) from a list of possible participants typically associated with the particular sporting event. The monitor can also select the proper participant-highlighting event using the program as well. An identification of the highlighted participants and the participant-highlighting event can be sent to the Application Server 20 at 126 via a dedicated network connection, an IP Network connection, or other suitable means for providing such information.

The Application Server 20 receiving this information can then make a request to a Sports Statistics Server 30 for the statistics associated with the one or more highlighted participants at 128. The Application Server 20 can determine the relevant statistics needed based on the type of participant-highlighting event and request these statistics only. Alternatively, the Application Server 20 can request all statistics related to the highlighted participant(s) and then select the relevant statistics from this group upon their receipt as described below.

The Statistics Server 30 retrieves the statistics for the highlighted participant(s) from a database at 130 and sends them to the Application Server 20 which receives them at 132.

The Application Server 20 determines what portion of the statistics should be sent to the subscriber(s) at 140. The Application Server 20 can use the subscriber-specific criteria provided by the Subscriber as described above to determine the statistics each individual Subscriber wants for the associated participant-highlighting event. Alternatively, the Application Server 20 can choose a pre-defined set of statistics for the participant-highlighting event. If the Application Server 20 receives all current statistics for the participant at 132, the Application Server 20 selects only the relevant statistics for the participant-highlighting event. This group can then be narrowed for each individual Subscriber according to the subscriber-specific criteria described above.

The Application Server 20 can also determine the format for sending the statistics to the subscribers' mobile handset(s) at 142. The Application Server 20 can determine the format for each Subscriber individually using the subscriber-specific criteria described above, if so desired.

The Application Server 20 communicates with the subscriber's MSC, sending a request for sending the statistics to the Subscriber at 144. The MSC receives the request and determines whether the Subscriber subscribes to the statistics service at 146. The MSC can determine this by checking with the Subscriber Database 18 described above. If the Subscriber does not subscribes to the service an error notice can be sent to the user at 148.

If the Subscriber subscribes to the service, the MSC sends the statistics to the subscriber's handset in the Subscriber requested format at 150. The entire sporting event is monitored in this manner and if it has not ended at 152, the monitoring step 120 continues and the steps described thereafter are repeated until the event ends at 154 or the service is deactivated.

As described above, this system and method of providing sports statistics to mobile handsets 12 occurs during the participant-highlighting event(s), or proximate in time thereto, such as within several seconds, so as to provide the Subscribers with an effective information gathering experience. The Subscribers can be attending the games and have the statistics provided to them during the participant-highlighting events as they watch them occur at the sporting venues. Or, the Subscribers can be watching the sporting events on television or listening to them on their radios while having the statistics delivered to them at those locations via their mobile handsets.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of providing sports statistics to one or more mobile telecommunications handsets during a sporting event comprising:
determining that the sporting event has begun;
determining that the sporting event has created a participant-highlighting event highlighting a participant in the sporting event;
obtaining a relevant group of the highlighted participant's sports statistics relevant to the participant-highlighting event;
determining one or more appropriate mobile telecommunications subscribers suitable for receiving the relevant group of highlighted participant's sports statistics; and
delivering at least portions of the relevant group of the highlighted participant's sports statistics to the one or more appropriate subscribers' mobile telecommunications handsets during or proximate the participant-highlighting event.

2. The method defined in claim 1 further comprising:
determining subscriber-specific criteria for each of the appropriate subscribers.

3. The method defined in claim 2 wherein the subscriber-specific criteria includes at least one of: a specific chosen sporting event, a participant-highlighting event occurring during the sporting event, a group of statistics chosen by the subscriber relating to the participant-highlighting event, and the delivery format for delivering the statistics to the subscriber's mobile telecommunications handset.

4. The method defined in claim 3 wherein the proper delivery format can include at least one of: a voice message, a Short Message Service (SMS) message, a text message, an email message, and a screen display.

5. The method defined in claim 1 wherein the obtaining step further comprises:
sending a query to an Application Server requesting the sports statistics for the highlighted participant, the query including an identification of the highlighted participant and an identification of the participant-highlighting event;
the Application Server sending a query to a Sports Statistics Server identifying the highlighted participant;
the Sports Statistics Server retrieving sports statistics for the highlighted participant; and
the Sports Statistics Server sending the retrieved sports statistics for the highlighted participant to the Application Server.

6. The method defined in claim 1 wherein the step of determining that the sporting event has created a participant-highlighting event further comprises manually monitoring the sporting event.

7. The method defined in claim 1 wherein the participant-highlighting event includes a baseball player coming up to bat.

8. The method defined in claim 1 wherein the participant-highlighting event includes at least one of the participant entering the sporting event, the participant leaving the sporting event, the participant being injured, the participant making a play in the sporting event.

9. A method of providing sports statistics to one or more mobile telecommunications handsets during a baseball game comprising:
determining that the baseball game has begun;
determining that the a baseball player is coming up to bat;
obtaining a relevant group of sports statistics relevant to the baseball player;
determining one or more appropriate mobile telecommunications subscribers suitable for receiving the relevant group of sports statistics; and
delivering at least portions of the relevant group of sports statistics to the one or more appropriate subscribers' mobile telecommunications handsets during or proximate to the baseball player coming up to bat.

10. The method defined in claim 9 further comprising:
determining subscriber-specific criteria for each of the appropriate subscribers, wherein the subscriber-specific criteria includes at least one of: a specific chosen baseball game, a participant-highlighting event chosen to be a baseball player coming up to bat, a group of statistics chosen by the subscriber relating to baseball players coming up to bat, and the delivery format for delivering the statistics to the subscriber's mobile telecommunications handset.

11. A system for providing sports statistics to one or more mobile telecommunications handsets during a sporting event comprising:
means for determining that the sporting event has begun;
means for determining that the sporting event has created a participant-highlighting event highlighting a participant in the sporting event;
means for obtaining a relevant group of the highlighted participant's sports statistics relevant to the participant-highlighting event;
means for determining one or more appropriate mobile telecommunications subscribers suitable for receiving the relevant group of highlighted participant's sports statistics; and
means for delivering at least portions of the relevant group of the highlighted participant's sports statistics to the one or more appropriate subscribers' mobile telecommunications handsets during or proximate the participant-highlighting event.

12. The system defined in claim 11 further comprising:
means for determining subscriber-specific criteria for each of the appropriate subscribers.

13. The system defined in claim 12 wherein the subscriber-specific criteria includes at least one of: a specific chosen sporting event, a participant-highlighting event occurring during the sporting event, a group of statistics chosen by the subscriber relating to the participant-highlighting event, and the delivery format for the subscriber's mobile telecommunications handset.

14. The system defined in claim 13 wherein the proper delivery format can include at least one of: a voice message, a Short Message Service (SMS) message, a text message, an email message, and a screen display.

15. The system defined in claim 11 wherein the means for obtaining the relevant group of the highlighted participant's sports statistics further comprises:
means for sending a query to an Application Server requesting the sports statistics for the highlighted participant, the query including an identification of the highlighted participant and an identification of the participant-highlighting event;
means for sending a query to a Sports Statistics Server identifying the highlighted participant;
means for retrieving sports statistics for the highlighted participant; and
means for sending the retrieved sports statistics for the highlighted participant to the Application Server.

16. The system defined in claim 11 wherein the means for determining that the sporting event has created a participant-highlighting event further comprises a person manually monitoring the sporting event.

17. The system defined in claim 11 wherein the participant-highlighting event includes a baseball player coming up to bat.

18. The system defined in claim 11 wherein the participant-highlighting event includes at least one of the participant entering the sporting event, the participant leaving the sporting event, the participant being injured, the participant making a play in the sporting event.
